(19) United States
(12) Patent Application Publication
(10) Pub. No.: US 2005/0245232 A1
(43) Pub. Date: Nov. 3, 2005

(54) Emergency response mission support platform

(76) Inventors: Robert Jakober, Haymarket, VA (US); Barry E. Henderson, Fairfax, VA (US)

Correspondence Address: The Law Office of Stephen R. Loe, P.O. Box 649, Frisco, TX, 75034, US

(21) Appl. No.: 10/836,370

(22) Filed: Apr. 30, 2004

(51) Int. Cl. H04L 9/00

(52) U.S. Cl. 455/410

(57) ABSTRACT

A method, system, and computer program software for an emergency management and response mission support platform for facilitating communication between a plurality of emergency response and management organizations is provided. In one embodiment, the platform includes an incident management and response unit and a portal. The incident management and response unit coordinates information between a plurality of emergence management and response organizations and provides substantially real-time operational information, such as, for example, location of emergency personnel and assets from a plurality of organizations, emergency response plans, and evacuation plan analysis, and delivers this information to users via a portal which provides a user interface to view content provided by the incident management and response unit. The portal is typically a web portal and the information is provided to any web enabled device, either wireless or wired, connected to the network and authorized to receive the information provided by the platform.

### BACKGROUND OF THE INVENTION

1. Technical Field

The present invention relates generally telecommunications, computer software, and information management, and, more specifically, to methods, systems, devices, and computer software for integrating information and resources for emergency response teams.

2. Description of Related Art

Today's work environment is inundated with information, and it can be challenging to filter and separate what is needed from background noise. Databases and network file systems are storing more and more data, and users are often unaware of where to look to find available information.

Many organizations are confronted with a collection of modern and older legacy information systems that provide content that is duplicative, un-sharable, and sometimes out-dated. These systems have been originally designed and deployed to satisfy specific business tasks, without the conception of a larger enterprise business process. Today it is common to see stacks of stovepipe systems, unable to interconnect with one another. This is especially true of the emergency response and management sectors of society. Furthermore, the ramifications of this problem in this sector are enormous for society as a whole; much more so than the effects of these problems in other areas.

Emergency managers and public safety officials at all levels recognize the current need for seamless, integrated, and timely access to information and services that support the complete lifecycle of disaster management. Emergency management life cycle processes include preparing for emergencies and disasters, responding to them when they occur, helping people and institutions recover from them, mitigating their effects, reducing the risk of loss, and preventing them from occurring.

A solution that fully supports the disaster management lifecycle would focus on and address the requirements of information and service providers-both government and non-government organizations, as well as the recipients, or end users of information and emergency services, which include businesses and the public.

It, therefore, would be desirable to have a method, system, and computer program product that increases information-sharing, situational awareness and coordination of resources and assets for public safety and emergency management professionals to that these professionals can manage their organizations more effectively and that enables First Responders, emergency managers, state and local public officials, and healthcare providers to get the information they need, when they need it, thereby enabling rapid and effective decision-making which is so crucial during emergency situations.

### SUMMARY OF THE INVENTION

The present invention provides a method, system, and computer program software for an emergency management and response mission support platform for facilitating communication between a plurality of emergency response and management organizations. In one embodiment, the platform includes an incident management and response unit and a portal. The incident management and response unit coordinates information between a plurality of emergence management and response organizations and provides substantially real-time operational information, such as, for example, location of emergency personnel and assets from a plurality of organizations, emergency response plans, and evacuation plan analysis, and delivers this information to users via a portal which provides a user interface to view content provided by the incident management and response unit. The portal is typically a web portal and the information is provided to any web enabled device, either wireless or wired, connected to the network and authorized to receive the information provided by the platform.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial diagram illustrating communication between various branches of emergency personal via an Emergency Response Mission Support Platform in accordance with one embodiment of the present invention;

FIG. 2 depicts a block diagram illustrating components of an exemplary MSP in accordance with one embodiment of the present invention;

FIG. 3 depicts a system diagram illustrating a distributed data processing system in which an emergency response communication system and mission support platform may be implemented in accordance with one embodiment of the present invention; and

FIG. 4 depicts a block diagram of a data processing system which may be implemented as a server, on which the MSP may be implemented in accordance with one embodiment of the present invention.

### DETAILED DESCRIPTION OF THE PREFERRED EMBODIMENT

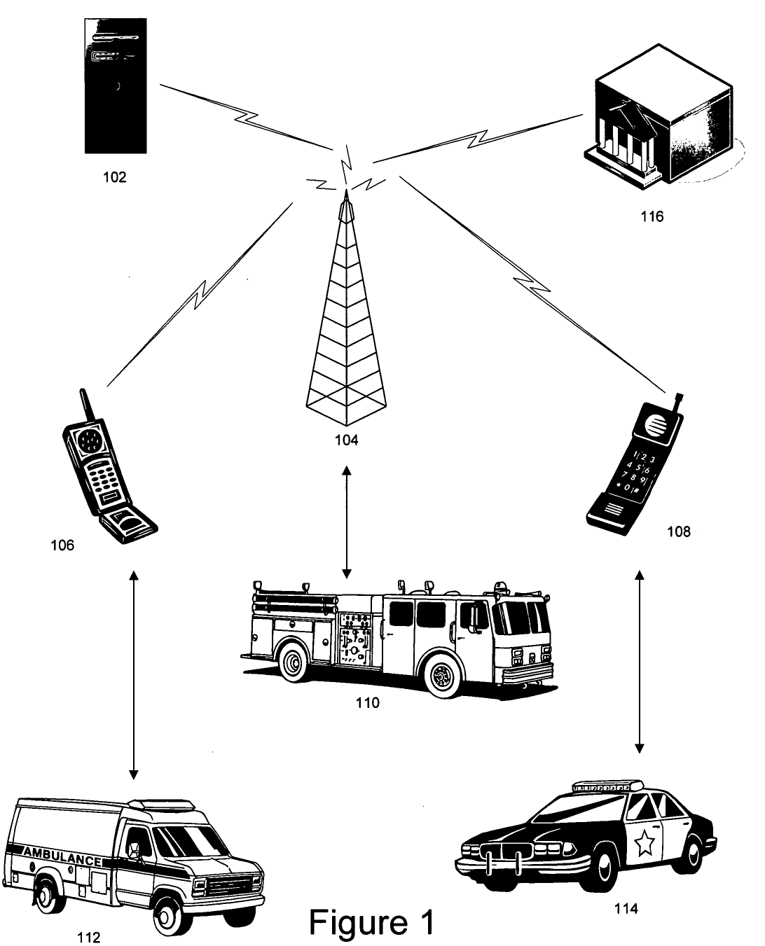

With reference now to the figures, and in particular with reference to FIG. 1, a pictorial diagram illustrating communication between various branches of emergency personal via an Emergency Response Mission Support Platform (“ES MSP” or simply “MSP) is depicted in accordance with one embodiment of the present invention. The MSP 102 of the present invention is a unique information technology architecture and methodology with which applications, content, and services are integrated to assist public safety, emergency and incident managers in responding to events, such as ambulance 112, fire department 110, and police department 114. The various emergency service providers 110-114 and ermergency management operation center (EOC) 116 wirelessly communicate with MSP 102 either directly through a radio or other wireless device mounted within a vehicle or via a handheld device, such as, for example, wireless handheld devices 106 and 108, which may be, for example, portable two-way radios. However, other devices, such as, for example, portable computers, wirelessly enabled personal digital assistants (PDAs), and wireless telephones, may be utilized as well in order to communicate with MSP 102. Transmissions to and from the MSP 102 may be facilitated by, for example, antenna 104. However, communication may also be facilitated via satellite or through a combination of satellite and ground based antenna systems. Furthermore, some systems, such as EOC 116 may be connected to MSP via wired transmission means, such as, for example, a high speed internet connection.

The MSP 102 is both a technology architecture and methodology process, with which information, applications and services are integrated and aggregated to a secure thin-client interface. An implementation of the MSP environment will empower users to access critical information, and manage resources in the pursuit of monitoring and responding to public safety related incidents and events.

The MSP 102 is not a turnkey system, not a set of products, and not a generalized “best fit” solution for all organizations. Rather, it is a systemic process to deploy a cohesive environment that is targeted for an organization's specific business needs using commercial off the shelf (COTS) solutions from “best of breed” vendors. The MSP 102 leverages, to the maximum extent possible, existing applications, information systems and data repositories that reside within the enterprise; while incorporating industry standard technologies and services.

The technology architecture provides a framework in which applications and services are interconnected in a secure environment. This allows information and data to be shared among systems and users.

The methodology of the MSP 102 provides a knowledge management focused analysis to define the organizational and business processes, content repositories, roles and responsibilities of personnel, and ultimately requirements to solve existing business needs. This achieves a business blueprint with which technical designs are developed to implement an integrated environment accessible through a web portal. This environment will empower users and deliver critical information to better enable them to make more informed decisions.

The MSP 102 provides, among other things, answers to common questions in the public safety communities:
“How can I find the information I need to make more informed decisions”,
“How can I share information with people I work with”,
“How can I better coordinate my resources and assets”,
“How can I better train my people”, and
“How can I improve my awareness of conditions at an incident”

The MSP 102 also solves these common information retrieval and integration problems. Unstructured information, such as documents, spreadsheets, and briefings are consolidated and managed using content management services. Structured disparate data, such as that residing within relational and hierarchical databases, are aggregated into virtual data repositories using business intelligence services. Information is then accessed through a business-focused taxonomy, and delivered using a “push” mechanism.

Integration with existing information systems is accomplished through a robust enterprise integration application (EAI) broker. This broker allows applications and services to exchange data. Even older legacy systems are able to interconnect with modern systems. Thus, MSP 102 facilitates communication between the various organizations that may respond to an incident or emergency without forcing each organization to switch to new communication hardware.

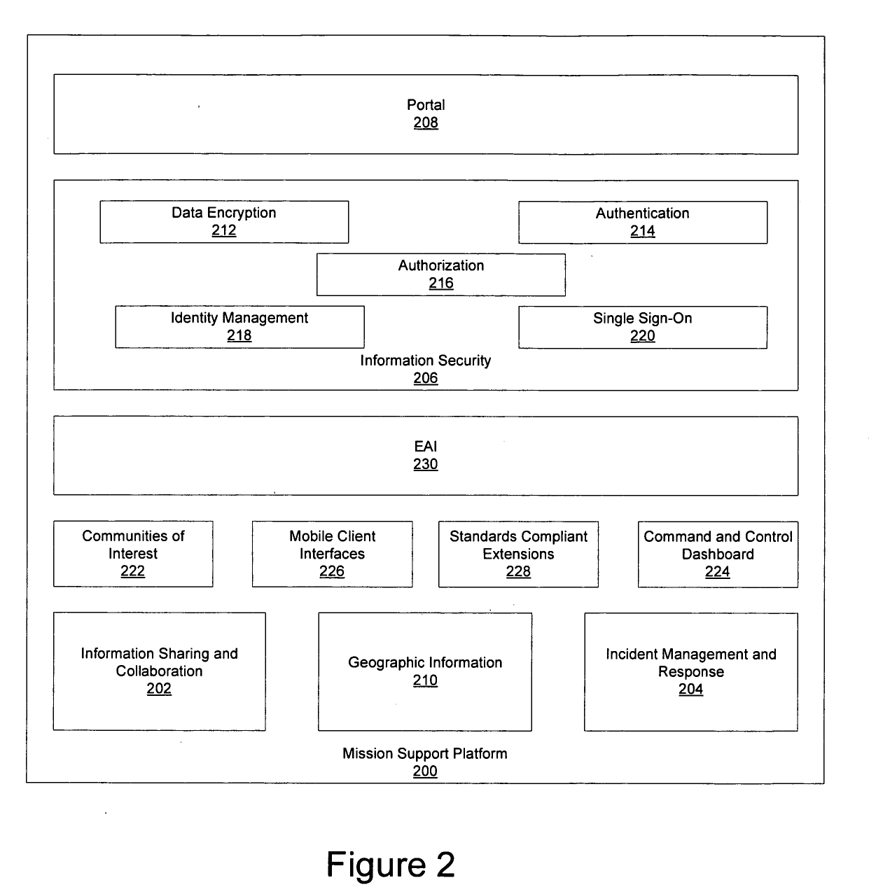

With reference now to FIG. 2, a block diagram illustrating components of an exemplary MSP is depicted in accordance with one embodiment of the present invention. Mission Support Platform (MSP) 200 is an example of an MSP that can be implemented as MSP 102 in FIG. 1. MSP 200 includes an Information Sharing and Collaboration (ISC) unit 202, a Geographic Information (GI) Unit 210, an Incident Management and Response (IMR) Unit 204, an Information Security (IS) Unit 206, an Enterprise Integration Application (EAI) broker 230, a Communities of Interest (COI) unit 222, a Command and Control Dashboard (CCD) unit 224, a Mobile Client Interface (MCI) unit 226, and a Standards Compliant Extensions (SCE) unit 228, and a Portal 208.

At the heart of MSP 200 is the ISC 202. ISC 202 consolidates and manages unstructured information, such as documents, spreadsheets, and briefings from various emergency response and management agencies using content management services. Structured disparate data, such as that residing within relational and hierarchical databases, are aggregated into virtual data repositories using business intelligence services. Information is then accessed through a business-focused taxonomy, and delivered using a “push” mechanism to the various emergency response and management agencies coordinated through MSP 200. Integration with existing information systems is accomplished through a robust enterprise integration application (EAI) broker 230. This broker 230 allows applications and services to exchange data. Even older legacy systems are able to interconnect with modern systems. Thus, ISC 202 facilitates the management of unstructured information and its use to communicate with user communities.

IMR 204 is integrated with an application component designed to assist public safety and emergency managers and directors in the coordination of resources and assets towards incidents and events. The IMR 204 in an integrated and comprehensive tool used to capture details of an on-going incident, manage the personnel, tasks, and assets assigned to it, and later provide after-action reports. The IMR 204 is a data repository of all information gathered during an incident and in preparation to support incidents. The IMR 204 provides comprehensive functionality for all critical tasks. In addition, the application manages:
Resource requests and tracking
Situation reports
Intelligence reports
Status and availability of assets and personnel
Response and recover capabilities and costs
Action and contingency plans
Staffing assignments
Alert notification
Audit history
After action reporting
   The information that the IMR 204 manages is visible and sharable to applications and services within the MSP 200.

GI 210 provides a powerful aid to a decision maker to better understand the conditions of the situation by supplementing the information with geographically oriented analysis. Thus, the GI 210 supplements the functionality of the IMR 204. More than a repository of maps and images, the GI 210 provides analysis that enables decision makers to determine how the situation impacts buildings, people, and public works infrastructure. For example, a plume model could be generated to determine the dispersion area and direction of a gas cloud or flood may be moving. This analysis will prioritize the evacuation of communities and properly locate shelters. If global positioning system (GPS) enabled wireless locate devices are available, near real-time positions of emergency personnel, assets and vehicles could be seen on detailed maps.

The MSP 200 is rooted with a robust and flexible information security service (IS) 206 that restricts access to authorized users. The IS 206 is pervasive throughout all content, applications, and services within the MSP 200 whereby a user's credentials are required for access. IS 206 comprises five areas: data encryption (DE) 212, authentication (A1) 214, authorization (A2) 216, identity management (IM) 218, and single sign-on (SSO) 220.

All data that is transmitted from the MSP 200 to a user's client or thin-client device (be it desktop, laptop, cell phone, PDA, or other device) is encrypted by DE 212 using for example, secure socket layer (SSL 3.0). Additional encryption protocols can be used, including public key infrastructure (PKI) and biometric mechanisms. The environment transmits secure hypertext transport protocol (HTTPS) data via the organization's Local Area Network (LAN), extranet, or the public Internet. The SSL encrypted data is keyed at, for example, 1024 bits.

Users are required to identify themselves prior to accessing the MSP 200 through A1 214. A1 214 challenges users with, for example, an account name and password. Administrators can enforce a multitude of authentication management policies with A1 214 to include password length and time expiration, and PKI client certificates.

In some embodiments, users are represented within groups and roles. These groups and roles are then assigned permissions to content within A2 216 of MSP 200. The administration of these groups and roles are managed by a delegated structure of administrators. Permissions relating to specific content are managed within each application or service, thereby creating a distributed administration structure.

User profiles reside within a central directory, IM 218. This central directory utilizes, for example, the lightweight directory access protocol (LDAP), to enable applications and services within the MSP 200 to authenticate users and access a vast array of attributes that define each user. One benefit of a central directory of user profiles is that it ensures that information is kept current, through non-duplication of information. It is commonly seen that duplication of user information is never kept up to date at all places. User contact information, in some embodiments, should include e-mail addresses and phone numbers thus ensuring that system generated alerts, notifications, and messages are accurately sent to users.

SSO 220 is a powerful capability that enables a user's authentication credentials to be passed to applications and services within the MSP 200. Currently, in other prior art systems, users commonly possess multiple accounts and are required to login to each application individually. The single sign-on capability requires that users login once, when initially contacting the MSP 200, but not have to re-login to each area within the system. The system passes the required account information to each application that would establish a trust that the user has successfully authenticated.

The user interface is implemented via portal 208, which in the example depicted in FIG. 2, is a web-based portal system. The portal 208 provides dynamically created pages, such as, for example, Hypertext Markup Language (HTML) pages, to view content, applications and services (these three types will be generally referred to as content). Each user has a unique view into how content is presented, and is capable of customizing the style and its layout. Unlike a static HTML web page, whereby users view the same presentation, a portal-based system allows users to personalize and shape the pages to suit their preferences. For example, users are able to organize content to a single page or multiple pages; to a single column on a page or multiple columns on a page. Portal 208 allows users to access various features of the MSP 200 via EAI broker 230 after successfully navigating security features of the IS 206.

The portal 208 is organized into a two level hierarchy. At the top, content is represented within a particular context relating to a community. A community is an area within the MSP 200 whereby content is presented in a specific context by a COI 222, for example fire protection, law enforcement, and medical communities would each have content that is tailored to each. Within each community, users can personalize in what style and layout the content is presented. The groups and roles that a user is associated with, grants them access to particular communities. For example, a user who may have responsibilities within the fire department would have access to the fire protection community. However, their access into the law enforcement community may be limited.

The CCD 224 is an area within the MSP 200 that is optimized to deliver information, applications, and services in the course of managing specific incidents. This specific area is the “crisis management” of the MSP 200. The organization and layout of content is customized for a decision maker's role and responsibility. It is an environment providing aggregated views into specific emergencies or incidents, leveraging the strengths of all components within the MSP 200.

The CCD 224 can enhance a manager's situational awareness into the scene of an incident by, for example, aggregating information about an incident or disaster into a single portal page or single view. The following capabilities are a sample of functionalities available within the CCD 224:
Monitor and manage resources and assets,
View maps, blueprints, floor plans, and possibly live video of the scene,
Monitor situation reports and logistical information,
Access planning, standard operating procedure, and response documents

The MCI 226 allows the portal 208 to support delivery of content to smaller screened devices as well as the more traditional larger screens associated with laptops and desktops. In addition to a desktop and laptop computer, the MCI 226 will resize the content to fit an abundance of client devices. Whether that device is a portal digital assistant (PDA) or a cellular phone, users will be able to access the MSP 200.

SCE 228 provides the portal 208 with the ability to support several industry integration and development standards that will in turn support continuous future expansions allowing the MSP 200 to upgrade as technology advances in the future. An initial deployment of the MSP 200 is a foundation towards an enterprise supporting system. Remote web-based applications and services can be seamlessly integrated. Java and Extensible Markup Language (XML) provide the technologies with which future applications, both internal to the organization and external are developed and can become future extended components.

Because MSP 200 is a modular design, additional components may be integrated as desired by the particular implementation or as desired in the future without having to scrap the MSP 200 and implement an entirely new MSP 200. For example, the MSP 200 may include a Content Management (CM) unit, a Collaboration Unit (CU), or a Learning Management (LM) unit.

Managing unstructured content, such as documents and spreadsheets can be a daunting task. Version control, duplicity, organization, and workflow are unachievable on network file systems alone. The CM component enables users to manage the life of a document, and enables users who are granted access, but are otherwise outside the LAN to access it. These specific capabilities include:
Version control and check-in, check-out
Access control on editing and reading
Hierarchical taxonomy
Robust search
Document workflow management
   It is very common that e-mail and telephone are the primary means of communication when exchanging information remotely. However, these mechanisms do not provide an efficient and effective means to control access nor the distribution of information. The CU is thus beneficial in groups where users are geographically dispersed. Coordination and collaboration can revolve around projects, activities, and content. Specific capabilities may include:
Text chatting and conferencing
Threaded discussions
Comments
E-Voting
Group calendaring
Task management
On-line meetings and briefings
Application sharing
Video conferencing

Maximizing training potential in an organization is important in an environment that is continuously changing with new techniques, and new problems. Training personnel through e-learning systems greatly lowers training costs, and improves skill sets and overall knowledge.

A powerful capability of the MSP 200, as implemented in some embodiments, is the integration of a learning management system (LM system). This component allows courses and quizzes to be distribute to personnel based upon their roles and responsibilities. Users and managers can quickly determine courses that are beneficial to their career growth, and can monitor their progress. In addition, facilities, instructors, and assets that are used in the training curriculum can be managed.

Another optional component is Business Intelligence (BI). The capabilities of this service component enable users to access disparate databases and to query, report, and be alerted to preset conditions. Using on-line analytical processing (OLAP), users view reports and graphs in a “drill down” method. Information is presented in a hierarchical arrangement, whereby more details are presented as the user requests it. If databases are available within an organization, or within reach of the organization, this service will establish virtual repositories that display data in simpler views.

The power of this BI is in its ability to notify users of anomalies. Preset conditions can be established to enable the service to continually query data until a threshold has been exceeded. When this occurs, the user will be alerted using profile contact attributes. For example, if the data exists to manage medical personnel availability; notifications can be sent to decision makers, if the level of personnel falls below preset minimum levels.

Another optional component is a Voice Enabled Interface (VEI). With the proliferation of cellular phones and radios, users can use these readily available devices to interface with the MSP 200. Application and service components within the system can be enabled to translate data into voice, which a user can interactively access via a phone or radio. For example, interactive voice alerting capabilities allow notices or alerts to be automatically sent to a user. Applications can also be designed to receive input via voice was as well. AS another example, a situation report can be phoned into the incident management and response tool.

Thus, the MSP 200 enables communities to prepare for, respond to, and recover from disasters and emergencies. The modular, customizable MSP 200 of the present invention also supports ongoing operations a the community level, uniting critical information into a central “Knowledge Portal” that improves the flow of knowledge across government agencies, first responders and others. With MSP 200, government elected officials, police, fire, and emergency medical personnel have the situational awareness they need to make quick, informed decisions and perform their jobs effectively. Communities will respond more quickly and efficiently, ultimately saving lives.

Thus, the MSP 200 includes the following benefits:
When an incident or emergency occurs, the “knowledge portal” is transformed into a “digital dashboard” to provide real time operational information (situational awareness) about the incident.
Built upon an open architecture and “best of breed” standards-based technologies, the MSP can be integrated with a state or local government's existing information technology architecture and legacy applications, which saves time and reduces implementation costs.
The MSP is Web-based and can be accessed from any computing or wireless device (work station, laptop, PDA, cell phone, etc.) that supports a Web browser. User access and authentication is role-based and can be controlled to the data and information type level.
The MSP is designed for daily user, as well as emergency response.
The solution integrates collaborative and information sharing security technologies, along with common office products and operations support tools, into a single work environment.
It can be used daily for e-mail, storing response plans, reporting operational status and tracking training certifications. By doing so, one will have the information at one's fingertips to broadly disseminate information, maintain situational awareness and bring the appropriately trained people to the scene during an emergency.

MSP 200 is provided as an example of an MSP and is not meant to imply that the components depicted are the only components that may be utilized in an MSP. The optional components discussed above as well as other components not discussed or described herein may be utilized as well. Thus, those skilled in the art will recognized that the present invention is not limited by the components depicted in FIG. 2.

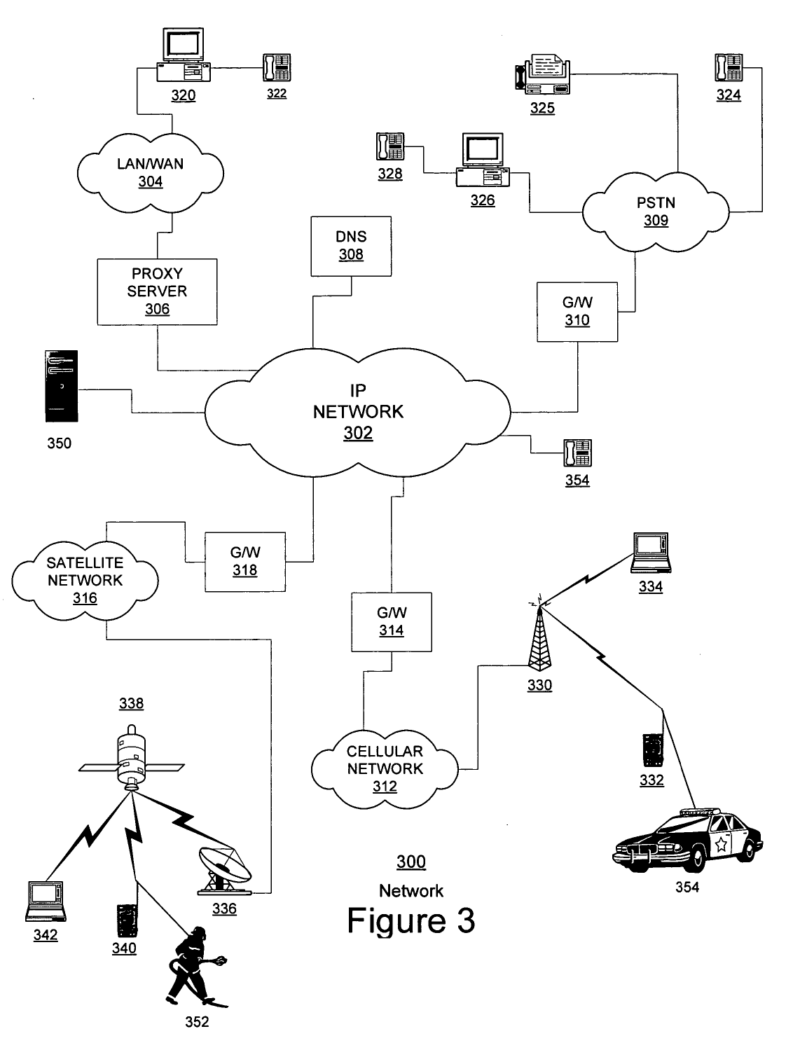

With reference now to the figures, and in particular with reference to FIG. 3, a system diagram illustrating a distributed data processing system in which an emergency response communication system and mission support platform may be implemented is depicted in accordance with one embodiment of the present invention.

Distributed data processing system 300 is a plurality of interconnected heterogeneous networks in which the present invention may be implemented. As illustrated, distributed data processing system 300 contains an Internet Protocol (IP) network 302, a Local Area Network (LAN)/Wide Area Network (WAN) 304, the Public Switched Telephone Network (PSTN) 309, a cellular wireless network 312, and a satellite communication network 316. Networks 302, 304, 309, 312, and 316 may include permanent connections, such as wire or fiber optic cables, or temporary connections made through telephone connections.

IP network 302 may be the publicly available IP network (the Internet), a private IP network, or a combination of public and private IP networks. In any case, IP network 302 operates according to the Internet Protocol and routes packets among its many switches and through its many transmission paths. IP networks are generally known in the art to be expandable, fairly easy to use and heavily supported. Coupled to IP network 302 is a Domain Name Server (DNS) 308 to which queries may be sent, such queries each requesting an IP address based upon a Uniform Resource Locator (URL). IP network 302 supports 32 bit IP addresses as well as 128 bit IP addresses, which are currently in the planning stage.

LAN/WAN 304 couples to IP network 302 via a proxy server 306 (or another connection). LAN/WAN 304 may operate according to various communication protocols, such as the Internet Protocol, the Asynchronous Transfer Mode (ATM) protocol, or other known packet switched protocols. Proxy server 306 serves to route data between IP network 302 and LAN/WAN 304. A firewall that precludes unwanted communications from entering LAN/WAN 304 may also be located at the location of proxy server 306.

A MSP 350 is coupled to IP network 302 and facilitates communication between various organizations that may be responding to an incident or event. MSP 350 may be implemented as, for example, MSP 200 depicted in FIG. 2.

Computer 320 couples to LAN/WAN 304 and supports communications with LAN/WAN 304. Computer 320 may employ the LAN/WAN and proxy server 306 to communicate with other devices across IP network 302. Such communications are generally known in the art and will not be further described herein except to expand upon the teachings of the present invention. As is also shown, phone 322 couples to computer 320 and may be employed to initiate IP Telephony communications with another phone or voice terminal using IP Telephony. In such an IP telephony system, a gatekeeper 352 is deployed by a service provider to manage IP telephony for its users. An IP phone 354 connected to IP network 302 (or other phone, e.g., phone 324) may communicate with phone 322 using IP telephony.

PSTN 309 is a circuit switched network that is primarily employed for voice communications, such as those enabled by a standard phone 324. However, PSTN 309 also supports the transmission of data. Data transmissions may be supported to a tone based terminal, such as a FAX machine 325, to a tone based modem contained in computer 326, or to another device that couples to PSTN 309 via a digital connection, such as an Integrated Services Digital Network (ISDN) line, an Asynchronous Digital Subscriber Line (ADSL), or another digital connection to a terminal that supports such a connection. As illustrated, a voice terminal, such as phone 328, may couple to PSTN 309 via computer 326 rather than being supported directly by PSTN 309, as is the case with phone 324. Thus, computer 326 may support IP telephony with voice terminal 328, for example.

Cellular network 312 supports wireless communications with terminals operating in its service area (which may cover a city, county, state, country, etc.). As is known, cellular network 312 includes a plurality of towers, e.g., 330, that each service communications within a respective cell. Wireless terminals that may operate in conjunction with cellular network 312 include wireless handsets 332 and wirelessly enabled laptop computers 334, for example. Wireless handsets 332 and wirelessly enabled laptop computers 334 enable emergency personal, such as, for example, police unit 354, to communicate with other emergency personal, such as, for example, firefighter 352, and receive vital information via MSP 350. Wireless handsets 332 could be, for example, personal digital assistants, wireless or cellular telephones, or two-way pagers. Cellular network 312 couples to IP network 302 via gateway 314.

Wireless handsets 332 and wirelessly enabled laptop computers 334 may communicate with cellular network 312 using, for example, a wireless application protocol (WAP). WAP is an open, global specification that allows mobile users with wireless devices, such as, for example, mobile phones, pagers, two-way radios, smartphones, communicators, personal digital assistants, and portable laptop computers, to easily access and interact with information and services almost instantly. WAP is a communications protocol and application environment and can be built on any operating system including, for example, Palm OS, EPOC, Windows CE, FLEXOS, OS/9, and JavaOS. WAP provides interoperability even between different device families.

WAP is the wireless equivalent of Hypertext Transfer Protocol (HTTP) and Hypertext Markup Language (HTML). The HTTP-like component defines the communication protocol between the handheld device and a server or gateway. This component addresses characteristics that are unique to wireless devices, such as data rate and round-trip response time. The HTML-like component, Wireless Markup Language (WML), defines new markup and scripting languages for displaying information to and interacting with the user. This component is highly focused on the limited display size and limited input devices available on small, handheld devices. For example, a typical cell phone may have only a 4×10-character display with 16-gray levels and only a numeric keypad plus up/down volume keys.

Cellular network 312 operates according to an operating standard, which may be the Advanced Mobile Phone System (AMPS) standard, the Code Division Multiple Access (CDMA) standard, the Time Division Multiple Access (TDMA) standard, or the Global System for Mobile Communications or Groupe Speciale Mobile (GSM), for example. Independent of the standard(s) supported by cellular network 312, cellular network 312 supports voice and data communications with terminal units, e.g., 332 and 334.

Satellite network 316 includes at least one satellite dish 336 that operates in conjunction with a satellite 338 to provide satellite communications with a plurality of terminals, e.g., laptop computer 342 and satellite handset 340. Satellite handset 340 could also be a two-way pager. Satellite network 316 may be serviced by one or more geosynchronous orbiting satellites, a plurality of medium earth orbit satellites, or a plurality of low earth orbit satellites. In any case, satellite network 316 services voice and data communications and couples to IP network 302 via gateway 318 allowing an emergency response person, such as, for example, firefighter 352, to use a handheld wireless device 340 or wirelessly enabled laptop 342, to communicate with other emergency personal and to receive vital information via MSP 350.

FIG. 3 is intended as an example and not as an architectural limitation for the processes of the present invention. For example, distributed data processing system 300 may include additional servers, clients, and other devices not shown.

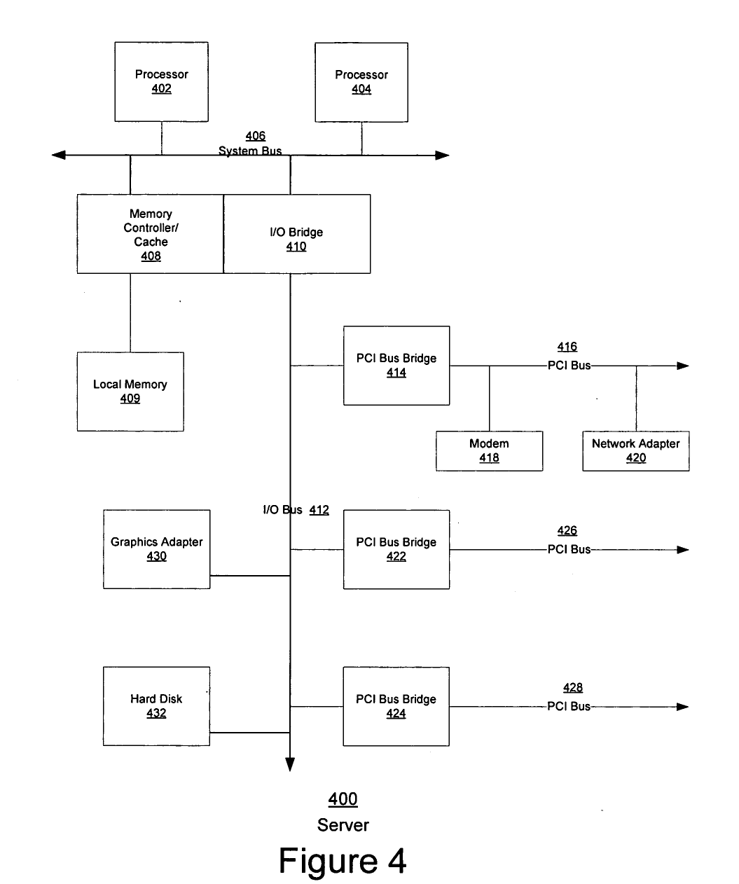

Referring to FIG. 4, a block diagram of a data processing system which may be implemented as a server in which an MSP, such as, for example, MSP 350 in FIG. 3, may be implemented, is depicted in accordance with one embodiment of the present invention. Data processing system 400 may be a symmetric multiprocessor (SMP) system including a plurality of processors 402 and 404 connected to system bus 406. Alternatively, a single processor system may be employed. Also connected to system bus 406 is memory controller/cache 408, which provides an interface to local memory 409. I/O bus bridge 410 is connected to system bus 406 and provides an interface to I/O bus 412. Memory controller/cache 408 and I/O bus bridge 410 may be integrated as depicted.

Peripheral component interconnect (PCI) bus bridge 414 connected to I/O bus 412 provides an interface to PCI local bus 416. A number of modems 418-420 may be connected to PCI bus 416. Typical PCI bus implementations will support four PCI expansion slots or add-in connectors. Communications links to network computers 152 and 156 in FIG. 1 may be provided through modem 418 and network adapter 420 connected to PCI local bus 416 through add-in boards.

Additional PCI bus bridges 422 and 424 provide interfaces for additional PCI buses 426 and 428, from which additional modems or network adapters may be supported. In this manner, server 400 allows connections to multiple network computers. A memory mapped graphics adapter 430 and hard disk 432 may also be connected to I/O bus 412 as depicted, either directly or indirectly.

Those of ordinary skill in the art will appreciate that the hardware depicted in FIG. 4 may vary. For example, other peripheral devices, such as optical disk drives and the like, also may be used in addition to or in place of the hardware depicted. The depicted example is not meant to imply architectural limitations with respect to the present invention.

Data processing system 400 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries.

Key features of an MSP according to one embodiment of the present invention are as follows:

Incident Management

quick and easy access by authorized users

browser-based, accessible from within an organization's LAN or the public Internet, mobile wireless client devices

customized pages for Communities of Interest

digital dashboard—provides real-time operational information

collaboration tools—application and document sharing, e-mail, threaded discussions, live chat, online meetings, group calendaring, video conferencing

storage of response plans, contingency plans, operating procedures, mutual aid agreements

operational status reporting; after-action reporting

alert/warning notification—multiple delivery modes

voice-to-text translations—interactive voice capabilities

Situational Awareness

fully integrated geographical information system (GIS) component-manages maps, images, and near-real time locations of emergency management personnel and assets, performs situation and impact analyses, plume modeling, GPS tracking, response/recovery costs, near real time access to computer aided dispatch system

real-time access to situation reports

metadata search engine, multiple data layers

streaming audio and video from the incident scene

Information Security

security, privacy tools

single sign-on, role based user authorization, central user directory

identity management, user profiles

data encryption

version control, check-in, check-out

access control on editing and reading

document workflow management

Resource and Asset Management

monitor resource/asset availability

manage and track resource requests

manage allocation of resources and assets—personnel, equipment, medical resources

manage staffing over time

manage evacuation plans

Trainig/e-Learning

Incorporates a learning management component to support e-learning: Users can:
take online courses and tests, track content updates and performance results
manage career development plans, certifications
access libraries, subject matter experts
search for specific skill sets
personalize learning and services
obtain standard and customized reports

Turning now to an example scenario which will illustrate some of the ways that the MSP of the present invention can help the emergency management community personnel perform their mission. Assume there has been an explosion at the Anaheim Convention Center and the initial indication is that the chemical agent is Sarin gas. The MSP sends out alerts to the Mayor's office and members of the emergency management community. The alerts go to a specified individual—to their computer, PDA, telephone, VHF radios, etc. Voice response is translated into text and personnel availability is determined. Using Geographic Imaging Systems from ESRI, the incident is mapped electronically and illustrated, for example, with plume technologies. The MSP provides the on-scene commander with information that will help to establish priorities and evacuation routes away from the center. Digital images and building plans of the convention center could also be provided on fire and police vehicle computers to help the fire and police personnel evacuate the facility. If additional HAZMAT personnel are needed, mutual assistance plans are accessed from an electronic repository and requests for assistance are automatically dispatched to surrounding communities. By integrating the MSP with local hospital databases, decisions can be made as to where individuals with specific injuries can be transported.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. An emergency management and response mission support platform for facilitating communication between a plurality of emergency response and management organizations, the platform comprising:
an incident management and response unit which coordinates information between a plurality of emergence management and response organizations and provides substantially real-time operational information; and
a portal which provides a user interface to view content provided by the incident management and response unit.

2. The platform as recited in claim 1, further comprising:
an information security unit for maintaining the security of information sent to and from the platform.

3. The platform as recited in claim 2, wherein the information security unit comprises a data encryption unit for encrypting and decrypting data sent from and received at the platform.

4. The platform as recited in claim 2, wherein the information security unit comprises an authentication unit for enabling a user to identify themselves to the platform.

5. The platform as recited in claim 4, wherein the user must supply a user name and password before being granted access to information from the platform.

6. The platform as recited in claim 2, wherein the information security unit includes an authorization unit for verifying determining which information a user is authorized to access.

7. The platform as recited in claim 2, wherein the information security unit provides a single sign-on allowing a user to sign on once and have access to all of the various applications running on the platform.

8. The platform as recited in claim 1, wherein the portal comprises a mobile client interface which supports the delivery of content to any device display regardless of display size.

9. The platform as recited in claim 1, wherein the portal supports a plurality of integration and development standards allowing for future expansions of the platform.

10. The platform as recited in claim 1, wherein the incident management and response unit provides at least one of resource requests and tracking, situation reports, intelligence reports, status and availability of assets and personnel, response and recover capabilities and costs, action and contingency plans, staffing assignments, alert notification, audit history, and after action reporting.

11. The platform as recited in claim 1, further comprising:
a geographical information unit which provides at least one of a repository of maps and images, analysis of geographical features of an incident, a plume model, near real-time positions of emergency personnel, assets, and vehicles, and analysis of evacuation plans in light of an incident in order to prioritize the evacuation of communities and properly locate shelters.

12. The platform as recited in claim 1, further comprising:
an information sharing and collaboration unit which aggregates structured disparate data from a plurality of emergency management and response organizations into virtual data repositories.

13. The platform as recited in claim 1, wherein the information sharing and collaboration unit consolidates and manages unstructured information assembled from a plurality of emergency management and response organizations using content management services.

14. The platform as recited in claim 1, further comprising:
a broker that integrates applications and services allowing the applications and services to exchange data.
